(19) United States
(12) Patent Application Publication
(10) Pub. No.: US 2026/0287805 A1
(43) Pub. Date: Sep. 24, 2026

(54) GRATING STRUCTURE AND PROCESSING METHOD THEREFOR, LENS AND HEAD-MOUNTED DISPLAY DEVICE

(71) Applicant: Goertek Optical Technology Co., Ltd., Shandong (CN)

(72) Inventors: Wenqiang Zhang, Shandong (CN); Yi Rao, Shandong (CN)

(73) Assignee: Goertek Optical Technology Co., Ltd., Shandong (CN)

(21) Appl. No.: 18/880,196

(22) PCT Filed: Feb. 23, 2023
(86) PCT No.: PCT/CN2023/077849

§ 371 Date: Dec. 30, 2024

(30) Foreign Application Priority Data
Jun. 30, 2022 (CN) 202210762788.4

(51) Int. Cl. G02B 5/18; G02B 27/01

(52) U.S. Cl. CPC G02B 5/1857; G02B 27/0172

(57) ABSTRACT

Disclosed are a grating structure and a processing method therefor, a lens, as well as a head mounted display. The grating structure includes a base and a plurality of grating portions provided on a surface of the base, the plurality of grating portions are arranged at intervals along an extension direction of the base, a surface of each of the grating portions are coated with an enhancement layer whose refractive index is greater than refractive index of the grating portions, and the enhancement layers coated on surfaces of at least two of the grating portions differs in thickness.

### CROSS-REFERENCE TO RELATED APPLICATIONS

The present disclosure is a National Stage of International Application No. PCT/CN2023/077849, filed on Feb. 23, 2023, which claims priority to Chinese Patent Application No. 202210762788.4, filed on Jun. 30, 2022, both of which are hereby incorporated by reference in their entireties.

### TECHNICAL FIELD

The present disclosure relates to the technical field of diffractive optical elements, and particularly to a grating structure and a processing method therefor, a lens, as well as a head mounted display.

### BACKGROUND

AR (Augmented Reality) display is a technology that calculates the position and angle of camera images in real-time and adds corresponding images, videos, 3D models thereto. The objective of this technology is to superimpose the virtual world onto the real world on the screen and enable interaction between them.

In AR displays, incident light typically emanates from an image source and enters the human eye after being reflected and refracted by the lens. Therefore, the performance of the lens directly impacts the image quality and user experience of the AR devices. It is known that the lens includes a substrate and a grating structure provided on the substrate, where the grating structure generally includes functional areas such as light coupling-in, pupil expansion, light coupling-out and the like, enabling light transmission imaging.

Materials currently used in the existing grating structures have relatively low refractive indices, leading to reduced light transmission efficiency and poor uniformity of color and brightness at different spatial positions or angles. However, selecting materials with higher refractive indices can increase processing difficulty, such as with direct etching methods, which not only raises processing costs but also makes mass production challenging.

### SUMMARY

In light of the aforementioned issues, aiming at the displaying problem that the grating structure has low refractive index and is uneven in color and brightness at different spatial positions and angles, there is a need to provide a grating structure and a processing method therefor, a lens, as well as a head mounted display, which is intended to effectively improve the refractive index and transmission efficiency of the grating, and adjust uniformity of color and brightness at different spatial positions and angles through coating thickness.

To achieve the above objective, the grating structure proposed by the present disclosure includes a base and a plurality of grating portions provided on a surface of the base, the plurality of grating portions being arranged at intervals along an extension direction of the base, wherein surfaces of the grating portions are coated with an enhancement layer whose refractive index is greater than refractive index of the grating portions, and the enhancement layer coated on surfaces of at least two of the grating portions differs in thickness.

Optionally, in an arrangement direction of the plurality of grating portions, the thickness of the enhancement layer coated on the surfaces of the grating portions gradually increases.

Optionally, each of the grating portions includes a top surface parallel to the surface of the base and a side surface connecting the top surface to the surface of the base, and the enhancement layer coated on the top surface and the side surface differs in thickness.

Optionally, in an arrangement direction of the plurality of grating portions, height of the grating portions is greater than width of the grating portions, and thickness of the enhancement layer coated on the top surface is greater than thickness of the enhancement layer coated on the side surface.

Optionally, the enhancement layer is made of one of titanium dioxide, aluminum oxide, and magnesium oxide.

Optionally, thickness of the enhancement layer coated on the surfaces of the grating portions ranges from 20 nm to 30 nm.

Optionally, the enhancement layer is coated through Atomic Layer Deposition, Chemical Vapor Deposition, Physical Vapor Deposition, or Magnetron Sputtering.

Optionally, the base is made of silica or resin;
and/or, the grating portions are made of silica or resin;
and/or, the grating structure is a binary grating, a blazed grating, an inclined grating or a multi-step grating.

The present disclosure also proposes a processing method for the grating structure, which includes following steps:
providing a base, with a plurality of grating portions arranged at intervals along an extension direction of the base on one surface thereof;
coating an enhancement layer on surfaces of the grating portions, with coating thickness of the enhancement layer on the surfaces of the grating portions being uniform;
coating photoresist on the enhancement layer;
partially covering the photoresist with a mask, and sequentially performing exposure and development on the photoresist to obtain retained photoresist;
increasing or reducing the thickness of the enhancement layer not covered by the retained photoresist so that the enhancement layer coated on surfaces of at least two of the grating portions differs in thickness.

Optionally, each of the grating portions includes a top surface parallel to the surface of the base and a side surface connecting the top surface to the surface of the base;
“partially covering the photoresist with a mask, and sequentially performing exposure and development on the photoresist to obtain retained photoresist” specifically includes:
using the mask to cover photoresist corresponding to the side surface and the surface of the base, or using the mask to cover photoresist corresponding to the top surface;
after exposure and development, the retained photoresist fills a groove space enclosed by the side surface and the surface of the base or is located on a surface of the enhancement layer coated on the top surface;
and, “increasing or reducing the thickness of the enhancement layer not covered by the retained photoresist so that the enhancement layer coated on surfaces of at least two of the grating portions differs in thickness” specifically includes:
increasing thickness of the enhancement layer coated on the top surface, or reducing thickness of the enhancement layer coated on the side surface, so that the enhancement layer of the surfaces on different positions of one of the grating portions differs in thickness.

Optionally, when the retained photoresist fills a groove space enclosed by the side surface and the surface of the base, “increasing thickness of the enhancement layer coated on the top surface, so that the enhancement layer of the surfaces on different positions of one of the grating portions differs in thickness” specifically includes:
controlling the retained photoresist to protrude from the groove space and be higher than thickness of the enhancement layer coated on the top surface;
re-coating an enhancement layer through evaporation or magnetron sputtering on the top surface of at least one of the grating portions, wherein thickness of a re-coated enhancement layer is less than a height by which the retained photoresist protrudes from the groove space.

Optionally, when the retained photoresist is located on a surface of the enhancement layer coated on the top surface, “reducing thickness of the enhancement layer coated on the side surface, so that the enhancement layer of the surfaces on different positions of one of the grating portions differs in thickness” specifically includes:
in the arrangement direction of the plurality of grating portions, controlling width of the retained photoresist to be less than width of the enhancement layer coated on the top surface, and setting a width difference between the enhancement layer coated on the top surface and the retained photoresist as t;
thinning thickness of the enhancement layer on the side surface of at least one of the grating portions, wherein reduced thickness of the enhancement layer on the side surface is less than or equal to t.

To achieve the above objective, the present disclosure also proposes a lens, which includes a substrate and any of the above grating structure, and a surface of the base facing away from the grating portions is attached to a surface of the substrate.

To achieve the above objective, the present disclosure also proposes a head mounted display, which includes an image source and the above lens, and the lens is located on a light-emergent side of the image source.

In the technical solution presented in the present disclosure, the grating structure includes the base and the plurality of grating portions provided on the base. By coating the enhancement layer (whose refractive index is higher than that of the grating portions) on the surfaces of the grating portions, when light is incident to the grating structure, it first reaches the surface of the enhancement layer. This indirectly increases the average refractive index of the grating structure, thereby increasing the difference between the refractive index of the grating structure and that of the air medium, which in turn enhances the diffraction efficiency of the grating. Compared to using materials with a high refractive indices, the present disclosure effectively reduces processing costs. Furthermore, by setting different thicknesses for the enhancement layer coated on surfaces of at least two grating portions, it becomes possible to adjust the uniformity of color and brightness across different areas of the image according to the thickness of the enhancement layer, thus achieving high transmission efficiency and uniformity for different colors in different areas and different angles.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a cross-sectional view of an embodiment of the grating structure according to the present disclosure;

FIG. 2 is a cross-sectional view of another embodiment of the grating structure according to the present disclosure;

FIG. 3 is a comparative chart showing the image output efficiency of different embodiments of the grating structure under one period condition in the present disclosure (wherein, a: grating structure without coating, b: coating layer with uniform thickness on top and side surfaces, c: coating layer with non-uniform thickness on top and side surfaces);

FIG. 4 is a process schematic diagram of physical vapor deposition coating for the grating structure according to the present disclosure;

FIG. 5 is a process schematic diagram of atomic layer deposition coating for the grating structure according to the present disclosure;

FIG. 6 is a flowchart of one embodiment of the processing method for the grating structure according to the present disclosure;

FIG. 7 is a structural schematic diagram corresponding to another embodiment of the processing method for the grating structure according to the present disclosure;

FIG. 8 is a structural schematic diagram corresponding to yet another embodiment of the processing method for the grating structure according to the present disclosure;

FIG. 9 is a cross-sectional view of an embodiment of the lens according to the present disclosure.

### DESCRIPTION OF REFERENCE SIGNS

| No. | Name | No. | Name |
|---|---|---|---|
| 100 | lens | 33 | grating portion |
| 10 | substrate | 331 | top surface |
| 30 | grating structure | 333 | side surface |
| 31 | base | 35 | enhancement layer |

The realization of the purpose of the present disclosure, its functional features and advantages will be further described with reference to the accompanying drawings in conjunction with the embodiments.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, and not all of them. Based on the embodiments in the present disclosure, all other embodiments obtained by a person of ordinary skill in the art without making creative labor fall within the scope of protection of the present disclosure

It should be noted that all directional indications (such as upper, lower, left, right, front, rear, . . . ) in the embodiment of the present disclosure are only used to explain the relative position and movement of the components in a specific posture (as shown in the attached figures); if the specific posture changes, the directional indication will change accordingly.

In addition, descriptions such as “first”, “second”, etc., in the present disclosure are for descriptive purposes only, and should not be understood as indicating or implying relative importance or implying a number of indicated technical features. Therefore, a feature delimited with “first”, “second” may expressly or implicitly include at least one of those features. In a description of the present disclosure, “a plurality” means at least two, such as two, three, etc., unless expressly and specifically defined otherwise.

In the present disclosure, unless expressly specified and limited otherwise, terms “connected”, “fixed” and other terms should be interpreted in a broad sense, for example, “fixed” can be a fixed connection, a detachable connection, or an integrated; it can be a mechanical connection or an electrical connection; it can be directly connected, or indirectly connected through an intermediate medium, and it can be an internal communication between two elements or an interaction relationship between the two elements, unless otherwise explicitly defined. For those of ordinary skill in the art, specific meanings of the above terms in the present disclosure can be understood according to specific situations.

Additionally, the technical solutions of the various embodiments of the present disclosure can be combined with each other, provided that such combinations are feasible for an ordinary skilled person in the field. When the combination of technical solutions is contradictory or unachievable, it should be considered that such a combination does not exist and falls outside the protection scope claimed by the present disclosure.

The efficiency of a diffraction grating is typically influenced by three primary factors: first, the difference in refractive index between the grating and air; second, the ratio of the width of the grating to air; third, the height of the grating. Due to limitations in processes and materials, it is difficult to apply the material with extremely high-refractive-index or the grating with a small width-to-height ratio. Therefore, the present disclosure proposes a grating structure, that achieves high diffraction efficiency and good uniformity by coating a film layer with high refractive index on the grating surface.

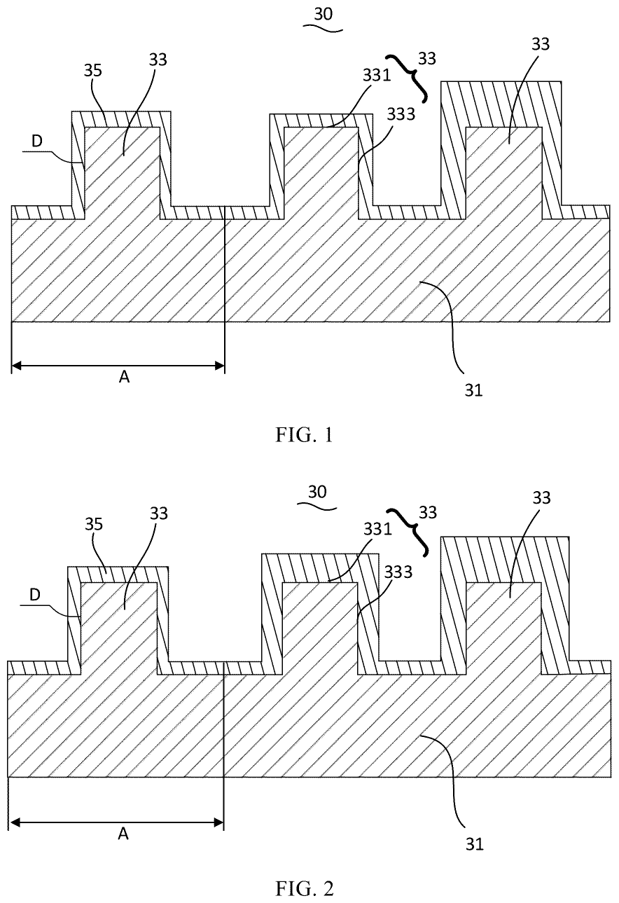

Please refer to FIGS. 1 and 2, in an embodiment of the present disclosure, the grating structure 30 includes a base 31 and a plurality of grating portions 33 provided on a surface of the base, the plurality of grating portions 33 are arranged at intervals along an extension direction of the base 31, surfaces of the grating portions 33 are coated with an enhancement layer 35 whose refractive index is greater than refractive index of the grating portions 33, and the enhancement layer 35 coated on surfaces of at least two of the grating portions 33 differs in thickness.

In the present embodiment, the grating structure 30 is applied to the lens 100 of a head mounted display (HMD), which includes an AR (Augmented Reality) display apparatus, and can also be used in MR (Mixed Reality) or XR (Extended Reality) display. The grating structure 30 includes the base 31 and the plurality of grating portions 33 provided on a surface of the base 31. Here, the material of the base 31 and the grating portions 33 may be the same, which facilitates processing. Specifically, the base 31 and the grating portions 33 are an integral molded structure. The grating structure 30 is processed on a substrate 10, such as a glass substrate 10. A coating is applied over this substrate 10, then pressed through a mold, and after demolding, the base 31 and the grating portion 33 of the above structure are obtained The plurality of grating portions 33 are arranged at intervals along the extension direction of the base 31, which can be its widthwise extension or lengthwise extension without limitation herein. When the grating portions 33 are arranged at intervals along the width direction of the base 31, they can extend along the length direction of the base 31, or when arranged at intervals along the length direction of the base 31, they can extend along the width direction of the base 31. Of course, the extension and arrangement directions of the grating portions 33 can also be at angles to the width direction of the base 31, which is not limited herein.

The surfaces of the grating portions 33 are coated with the enhancement layer 35, whose material is not limited but should have a refractive index greater than that of the grating portions 33, and may be correspondingly chosen according to the material of the grating portions 33. For example, the refractive index of the material of the grating portions 33 is generally below 2, and then the refractive index of the enhancement layer 35 is set above 2, or it is set to be 1.25 times or more of the refractive index of the grating portions. To save costs, optionally, the material of the base 31 is typically silica (refractive index of 1.45) or resin (refractive index of 1.5), with the grating portions 33 made of the same material as the base 31, i.e., silica or resin. Therefore, the material of the enhancement layer 35 could be selected from one of titanium dioxide (refractive index of 2.76 to 2.55), aluminum oxide (refractive index of 1.76), and magnesium oxide (refractive index of 1.732), thereby increasing the average refractive index of the grating structure 30, enhancing the difference between the refractive index of the grating structure 30 and that of air, and thus improving the diffraction efficiency of the grating. Titanium dioxide, in particular, can achieve better diffraction efficiency and image uniformity, effectively ensuring high transmission performance of the grating structure 30. Of course, as the refractive index of the enhancement layer 35 gradually increases, the uniformity and efficiency of the transmitting image are improved, but the increase magnitude tends to be stable. Therefore, based on cost considerations, there is no need to set the refractive index of the enhancement layer 35 extremely high.

It can be understood that the grating structure 30 can be a conventional binary rectangular grating, or it can be a blazed grating (serrated), an inclined grating or a multi-step grating and the like, which is not limited herein. Due to the various shapes of the grating portions 33, or when the angle or position of the grating structure 30 relative to the incident light differs, the diffraction angle of the grating for the light is different. To adjust the color uniformity at different positions or angles, the enhancement layer 35 coated on at least two grating portions 33 differs in thickness, and thus it is possible to reasonably design the thickness of the enhancement layer 35 coated on the grating portions 33 at different positions as needed, thereby achieving the purpose of adjusting brightness uniformity. Of course, the thickness of the enhancement layer 35 coated on the plurality of grating portions 33 of the grating structure 30 may all be set differently, or some can be different while others are the same, or the thickness can be different on some surfaces or all surfaces of two grating portions 33.

In the technical solution presented in the present disclosure, the grating structure 30 includes the base 31 and the plurality of grating portions 33 provided on the base 31. By coating the enhancement layer 35 (whose refractive index is higher than that of the grating portions 33) on the surfaces of the grating portions 33, when light is incident to the grating structure 30, it first reaches the surface of the enhancement layer 35, which indirectly increases the average refractive index of the grating structure 30, that is, increases the difference between the refractive index of the grating structure 30 and that of the air medium, thereby enhancing the diffraction efficiency of the grating. Compared with the case of a material with a high refractive index as a whole, the present disclosure effectively reduces the processing cost. Moreover, by setting different thicknesses for the enhancement layer 35 coated on surfaces of at least two grating portions 33, it is possible to adjust the uniformity of color and brightness of the image according to the thickness of the enhancement layer 35 in different areas, so as to obtain high transmission efficiency and uniformity of different colors in different areas and different angles.

Please continue to refer to FIG. 2, optionally, in an arrangement direction of the plurality of grating portions 33, the thickness of the enhancement layer 35 coated on the surfaces of the grating portions 33 gradually increases.

In the present embodiment, to achieve more uniform image display, in the extension direction of the grating structure 30, when the incident light is relatively close to one end of the extension direction, in order to improve the diffraction efficiency of the grating portions 33 that are farther away from the incident light, it is possible to enable that in an arrangement direction of the plurality of grating portions 33, the thickness of the enhancement layer 35 coated on the surfaces of the grating portions 33 gradually increases, so as to compensate for the differences in diffraction efficiency caused by different positions, thereby obtaining high transmission efficiency and uniformity for different colors in various regions and angles. Of course, the arrangement direction may be the extension direction from one end to the other end of the base 31 or from the other end to one end.

Optionally, the thickness of the enhancement layer 35 coated on the surfaces of the grating portions 33 ranges from 20 nm to 30 nm.

In the present embodiment, since the diffraction efficiency of the grating structure 30 is proportional to its overall refractive index, the thickness of the coated enhancement layer 35 should not be too small. However, there are also certain requirements for the height and width of the grating structure 30, so the thickness of the coated enhancement layer 35 should not be too large either. Here, the thickness of the enhancement layer 35 coated on the surfaces of the grating portions 33 is set to range from 20 nm to 30 nm, for example, 20 nm, 22 nm, 25 nm, 27 nm, 30 nm, etc., thus providing good diffraction efficiency.

Please continue to refer to FIG. 2, optionally, each of the grating portions 33 includes a top surface 331 parallel to the surface of the base and a side surface 333 connecting the top surface 331 to the surface of the base 31, and the enhancement layer 35 coated on the top surface 331 and the side surface 333 differs in thickness.

In the present embodiment, taking the grating structure 30 as an example of a conventional binary grating, each grating portion 33 includes the top surface 331 and the side surface 333. Here, the top surface 331 may be provided perpendicular or at an angle to the side surface 333. Since the geometric shape of the grating portion 33 also affects diffraction efficiency, when the light projects to the grating structure 30, the light received by the top surface 331 is also different from that received by the side surface 333. To further ensure the uniformity of the overall refractive index of the grating structure 30, some grating portions 33 have the enhancement layer 35 coated on their top surface 331 and side surface 333 with varying thicknesses.

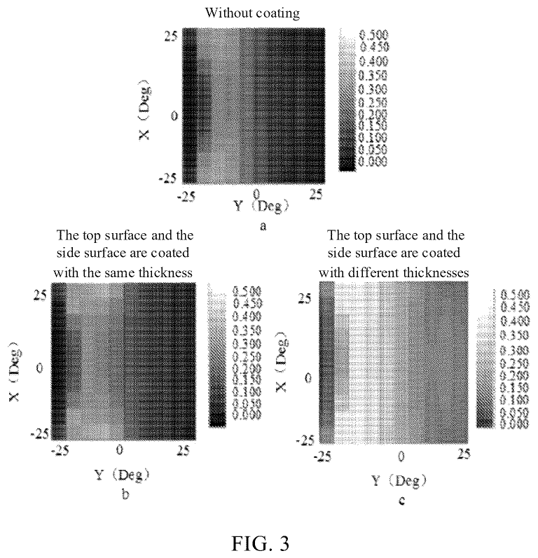

Please refer to FIG. 3, when the period A of the grating structure 30 is 375 nm, the image comparison diagrams of the three embodiments a, b, and c in the figure may be obtained by comparing the structure without coating and the structure coated with the enhancement layer 35, wherein thickness range of the coated enhancement layer 35 follows the above values, with a refractive index of 1.9 for the coated enhancement layer 35. In the figures, the abscissa represents the angle between the incident light and the Y-axis of the plane on which the grating structure 30 lies, while the ordinate represents the angle between the light and the X-axis of the plane on which the grating structure 30 lies. It should be understood that each image has a diagonal field of view angle of 35° and an aspect ratio of 1:1. In the figure, each grid with a different grayscale represents a large block of pixels, wherein a lighter gray color indicates higher diffraction efficiency at the corresponding light angle.

The results from coating the enhancement layer 35 on the surfaces of the grating portions 33 show that compared to the uncoated grating sample in a, the diffraction efficiency and uniformity of the grating structures 30 coated with the enhancement layer 35 in b and c are both improved. Wherein, the diffraction efficiency and uniformity obtained from the grating structure 30 in b where the top surface 331 and the side surface 333 are coated with the same thickness, are inferior to those in c where the top surface 331 and the side surface 333 are coated with different thicknesses. Therefore, the technical solution of the present embodiment can effectively improve the brightness and uniformity of the image of the head mounted display to which the grating structure 30 is applied, enhancing user's experience.

Please refer to FIG. 2, optionally, in an arrangement direction of the plurality of grating portions 33, height of the grating portions 33 is greater than width of the grating portions 33, and thickness of the enhancement layer 35 coated on the top surface 331 is greater than thickness of the enhancement layer 35 coated on the side surface 333.

In the present embodiment, the grating structure 30 is of a tall and slim type, meaning that the height of the grating portion 33 is greater than its width. Here, the thickness of the enhancement layer 35 coated on the top surface 331 is made thicker than that on the side surface 333. This allows for design according to the angle of the corresponding incident light, so as to ensure an alternating distribution between each surface and the air medium, achieve a more ideal average refractive index value, and therefore result in better diffraction efficiency.

Of course, when the grating structure 30 is of another type, such as a short and wide type, adjustments can be made according to actual conditions. This may allow to compensate for height of the grating structure 30, so that each surface has an equal chance of contacting the air medium, thereby ensuring uniformity and improving diffraction efficiency.

Optionally, the enhancement layer 35 is coated through Atomic Layer Deposition, Chemical Vapor Deposition, Physical Vapor Deposition, or Magnetron Sputtering.

Specifically, the enhancement layer 35 is provided on the surfaces of the grating portions 33 through a coating process. This coating process may be performed using Atomic Layer Deposition (ALD), Chemical Vapor Deposition (CVD), Physical Vapor Deposition (PVD), or Magnetron Sputtering. These coating processes are relatively simple, and compared to the etching process, they effectively reduce processing costs while enhancing the refractive index of the material. Additionally, these coating processes are suitable for large-scale mass production of gratings, thereby increasing production capacity.

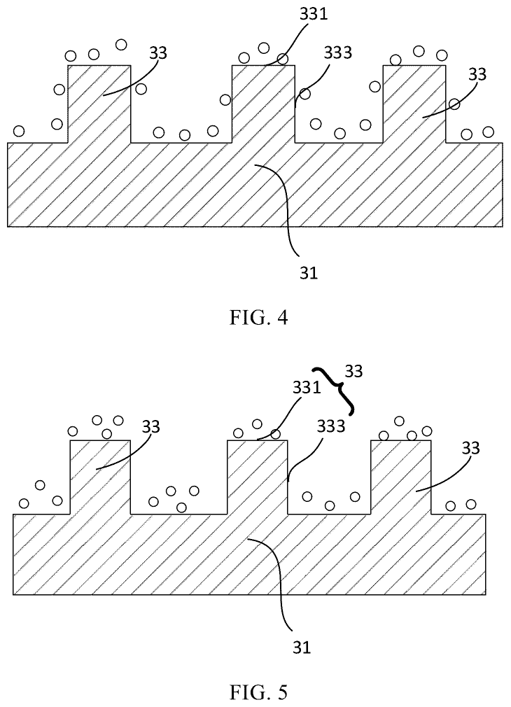

Please refer to FIG. 4, due to the differences in coating methods among various coating processes, the uniformity of the formed enhancement layer 35 can vary, and thus influence on the diffraction efficiency is different. When the grating portions 33 of the grating structure 30 are relatively flat with minimal undulation, that is, when the height of the grating portions 33 is small and the distance between two adjacent grating portions 33 is large, such as the blazed grating, the PVD coating process may be selected. In this process, the material for the enhancement layer 35 is directly evaporated by an electron beam or a heating wire, and is finally deposited layer by layer on the surfaces of the grating portions 33 to return to a solid state to form a film layer. This is a direct deposition from the material source to the sample to be coated. Therefore, this process is constrained by the shape and surface of the grating structure 30 but can form a better film layer effect for a relatively flat grating structure

Please refer to FIG. 5, for other types of the grating structures 30, ALD can be chosen for the coating process, and is a thin-film deposition process. Based on the chemical vapor deposition in which the flow sequence is strictly controlled, the coating material can be directly grown on the surface of the grating portion 33 layer by layer through the chemical reaction so as to be uniformly attached in all directions and at all angles, that is, the coating material is well attached and deposited on the top surface 331 and the side surface 333, without being constrained by the shape and surface of the grating structure 30. This process can achieve uniform, dense, and conformal film layers on various irregularly shaped grating structures. Therefore, by coating the enhancement layer 35 using this process, it is possible to effectively improve diffraction efficiency and uniformity, and typically increase light transmission efficiency by 50% to over 200%, thereby better matching the requirements of human visual experience and significantly enhancing the performance and applicability of the head mounted display.

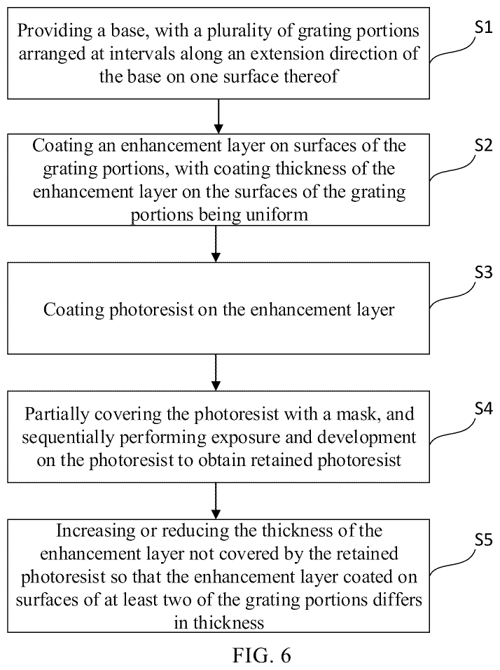

Please refer to FIGS. 6 to 8, the present disclosure also proposes a processing method for the grating structure, and this grating structure may be the grating structure according to any one of the above embodiments. The processing method includes following steps:
S1: providing a base 31, with a plurality of grating portions 33 arranged at intervals along an extension direction of the base 31 on one surface thereof;
S2: coating an enhancement layer 35 on surfaces of the grating portions 33, with coating thickness of the enhancement layer 35 on the surfaces of the grating portions 33 being uniform;
S3: coating photoresist on the enhancement layer 35;
S4: partially covering the photoresist with a mask, and sequentially performing exposure and development on the photoresist to obtain retained photoresist;
S5: increasing or reducing the thickness of the enhancement layer 35 not covered by the retained photoresist so that the enhancement layer 35 coated on surfaces of at least two of the grating portions 33 differs in thickness.

In the present embodiment, in the step S1, the base 31 is provided, on which the plurality of grating portions 33 are provided. Specifically, one can refer to the structure of the base 31 and the grating portions 33 as described in the above embodiment, which is not repeated herein. In the step S2, the enhancement layer 35 is coated on the surfaces of the grating portions 33. The coating method may be any of those mentioned previously, such as Atomic Layer Deposition, Chemical Vapor Deposition, Physical Vapor Deposition, or Magnetron Sputtering. Of course, while coating the enhancement layer 35 on the surfaces of the grating portions 33, it is also applied onto the surface of the base 31. Here, the thickness of the film layer of the coated enhancement layer 35 must be uniform at any location, with the thickness determined based on the minimum required thickness for the enhancement layer 35. Following this, in the step S3, applying photoresist over the enhancement layer 35, here, means that applying the enhancement layer 35 at any locations and enabling the photoresist to cover the surfaces of grating portions 33 uniformly. Then, performing “partially covering the photoresist with a mask” in the step S4 means that designing patterns on the mask so that some structures of the photoresist are covered while others remain uncovered, and after performing exposure and development, the uncovered photoresist may be removed while the covered photoresist may be retained, therefore forming the retained photoresist. Finally, in the step S5, individually altering the thickness of the enhancement layer 35 not covered by the retained photoresist so that the thickness of the enhancement layer 35 here is different from the thickness of the enhancement layer 35 at other positions, so as to ensure that the enhancement layer 35 on surfaces of at least two grating portions 33 differs in thickness. For example, one of the two adjacent grating portions 33 is covered by the retained photoresist, and the thickness of the enhancement layer 35 of the other grating portion 33 may be increased or decreased, so as to realize the difference in thickness, thereby ensuring that the uniformity of color and brightness of the image is controlled.

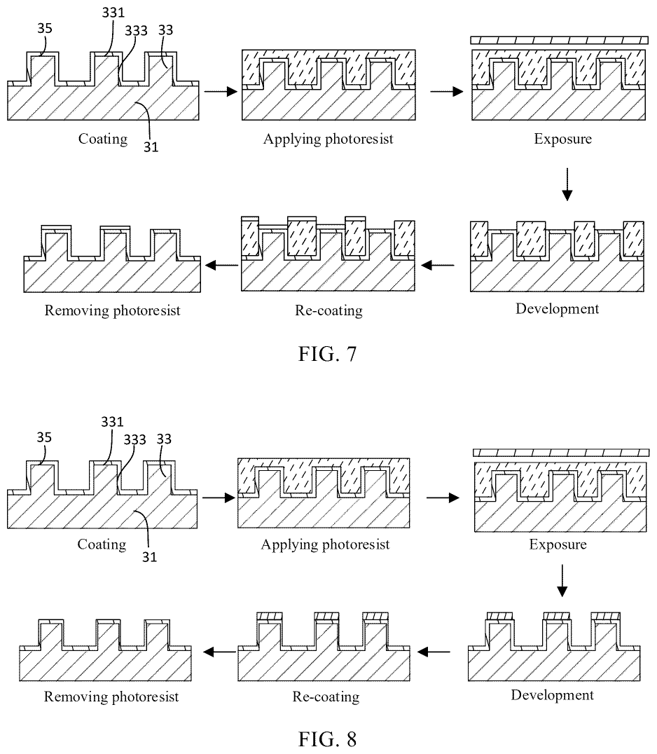

Please refer to FIGS. 7 and 8, optionally, each of the grating portions 33 includes a top surface 331 parallel to the surface of the base 31 and a side surface 333 connecting the top surface 331 to the surface of the base 31;
“partially covering the photoresist with a mask, and sequentially performing exposure and development on the photoresist to obtain retained photoresist” in step S4 specifically includes:
S41: using the mask to cover photoresist corresponding to the side surface 333 and the surface of the base 31, or using the mask to cover photoresist corresponding to the top surface 331;
S42: after exposure and development, the retained photoresist fills a groove space enclosed by the side surface 333 and the surface of the base 31 or is located on a surface of the enhancement layer 35 coated on the top surface 331;
and, “increasing or reducing the thickness of the enhancement layer 35 not covered by the retained photoresist so that the enhancement layer 35 coated on surfaces of at least two of the grating portions 33 differs in thickness” in step S5 specifically includes:
S51: increasing thickness of the enhancement layer 35 coated on the top surface 331, or reducing thickness of the enhancement layer 35 coated on the side surface 333, so that the enhancement layer 35 of the surfaces on different positions of one of the grating portions 33 differs in thickness.

In the present embodiment, when the grating portion 33 includes the top surface 331 and the side surface 333, during the initial coating process, both the top surface 331 and the side surface 333 are coated with the enhancement layer 35. To further improve the regulation accuracy, thicknesses for the enhancement layer 35 on the top surface 331 and the side surface 333 of one particular grating structure may be chosen to be different. That is, in step S41, during the cover processing with the mask and the exposure processing, either the top surface 331 or the side surface 333 may be covered, that is, it is possible to obtain the photoresist in step S42 corresponding to the top surface 331, or obtain the photoresist corresponding to the side surface 333 and the surface of the base 31. In this way, when the height of the grating portions 33 is greater than its width, corresponding to the above step S42, when the retained photoresist fills a groove space enclosed by the side surface 333 and the surface of the base 31 in S42, then performing the subsequent step S51, increasing thickness of the enhancement layer 35 coated on the top surface 331. The top surface 331 referred to here may be the top surface 331 of a particular grating portion 33 or the top surfaces 331 of a plurality of grating portions 33, which is not limited herein but rather set as needed, so that the thickness of the film layer coated on the top surface 331 of the grating portion 33 is greater than that on the side surface 333, thereby enhancing diffraction efficiency and uniformity. The method of re-coating is also not limited but can be any of those mentioned previously.

When the retained photoresist is located on a surface of the enhancement layer 35 coated on the top surface 331 in S42, then reducing thickness of the enhancement layer 35 coated on the side surface 333 in step S51, so that the thickness of the film layer coated on the top surface 331 of the grating portion 33 is greater than that on the side surface 333, thereby enhancing diffraction efficiency and uniformity. The method of reducing thickness is also not limited but can be a reactive etch or a non-reactive etch, etc.

Please refer to FIG. 7 again, optionally, when the retained photoresist fills a groove space enclosed by the side surface 333 and the surface of the base 31, “increasing thickness of the enhancement layer 35 coated on the top surface 331, so that the enhancement layer 35 of the surfaces on different positions of one of the grating portions 33 differs in thickness” in step S51 specifically includes:
S511: controlling the retained photoresist to protrude from the groove space and be higher than thickness of the enhancement layer 35 coated on the top surface 331;
S512: re-coating an enhancement layer 35 through evaporation or magnetron sputtering on the top surface 331 of at least one of the grating portions 33, wherein thickness of a re-coated enhancement layer 35 is less than a height by which the retained photoresist protrudes from the groove space.

In the present embodiment, referring to FIG. 7, when the retained photoresist is left in the groove space enclosed by the side surface 333 and the surface of the base 31, it is possible to ensure that the thickness of the enhancement layer 35 coated on the side surface 333 is not changed, which is the thickness dimension at the time of the first coating. In this way, when performing S511 again, the retained photoresist protrudes from the groove space, meaning that the height of the retained photoresist exceeds that of the groove space. Moreover, the height of the protruding part is greater than the thickness of the enhancement layer 35 initially coated on the top surface 331, thus allowing a portion of the photoresist to be exposed.

When performing the step S512 again, the enhancement layer 35 is selectively coated again on the top surface 331 of the grating part 33, and the overall thickness of the re-coated enhancement layer 35 and the enhancement layer 35 coated for the first time is smaller than the height of the retained photoresist, that is, after the re-coating, at least part of the photoresist is exposed.

In this way, after the above steps are completed, the photoresist is finally removed, that is, the photoresist removal process is performed. Here, a chemical agent such as acetone can be used for soaking, and the retained photoresist structure can be easily removed by setting a partially exposed structure, so as to complete the processing of the grating structure. The final coating structure obtained by the above processing method can realize the regionalized coating of the grating structure and accurately control the film thickness, and finally the light transmission efficiency is better improved by more than 50% to 200%. The above may better match the needs of human eye's experience and enhance the experience and applicability of augmented reality products.

Please refer to FIG. 8, optionally, when the retained photoresist is located on a surface of the enhancement layer 35 coated on the top surface 331, “reducing thickness of the enhancement layer 35 coated on the side surface 333, so that the enhancement layer 35 of the surfaces on different positions of one of the grating portions 33 differs in thickness” in step S51 specifically includes:
S513: in the arrangement direction of the plurality of grating portions 33, controlling width of the retained photoresist to be less than width of the enhancement layer 35 coated on the top surface 331, and setting a width difference between the enhancement layer 35 coated on the top surface 331 and the retained photoresist as t;
S514: thinning thickness of the enhancement layer 35 on the side surface 333 of at least one of the grating portions 33, wherein reduced thickness of the enhancement layer 35 on the side surface 333 is less than or equal to t.

In the present embodiment, when the photoresist is located on a surface of the enhancement layer 35 coated on the top surface 331, the thickness of the film layer coated on the top surface 331 is the same as the thickness during the initial coating, which is the thickness required by design. At this point, precise processing may be performed on the thickness of the enhancement layer 35 coated on the side surfaces 333. At this point, in the step S513, it is necessary to ensure that the width of the retained photoresist is less than the width of the enhancement layer 35 coated on the top surface 331. When the height of the grating portion 33 is greater than its width, thinning treatment on the thickness of the enhancement layer 35 on the side surfaces 333 of the grating portion 33 can be carried out, and the thinning method here can use reactive ion etching (RIE), laser etching, ion bombardment, and the like, which is not limited herein. Thus, during etching, the width difference t allows for easier thinning of the enhancement layer 35 on the side surfaces 333 and provides a positioning effect to some extent, thereby ensuring the accuracy of the thinning process.

In this way, after the above steps are completed, the photoresist is finally removed, that is, the photoresist removal process is performed. Here, a chemical agent such as acetone can be used for soaking to achieve the effect of removing photoresist, thereby completing the processing of the grating structure. The final coating structure obtained by the above processing method can realize the regionalized coating of the grating structure and accurately control the film thickness, and finally the light transmission efficiency is better improved by more than 50% to 200%. The above may better match the needs of human eye's experience and enhance the experience and applicability of augmented reality products.

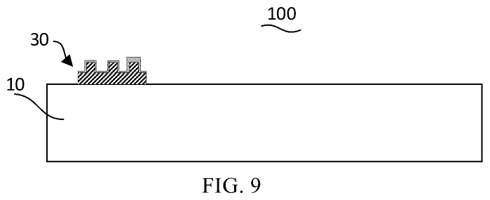

Please refer to FIG. 9, to achieve the above objective, the present disclosure also proposes a lens 100, which includes a substrate 10 and the grating structure 30 according to any one of the above, and a surface of the base 31 away from the grating portions 33 is attached to a surface of the substrate 10. Since the grating structure 30 of the lens 100 of the present disclosure refers to the structure of the grating structure 30 according to any one of the above embodiments, the advantageous effects brought about by the above embodiments will not be described in detail again.

In the present embodiment, the lens 100 may be a light waveguide lens 100 or composed of a plurality of convex and concave lenses 100, which is not limited herein. Wherein, the substrate 10 is made of a transparent material, such as glass, which may have a two-dimensional structure, i.e., flat. In one embodiment, the substrate 10 includes two opposite surfaces, which allows incident light to be transmitted with total internal reflection through the setting of the incident light and the coupled-in grating. The grating structure 30 coated with a film layer may be a coupling-in grating, which is provided on a surface of the substrate 10 and is capable of coupling the incident light into the substrate 10, thereby enhancing light transmission efficiency. Of course, the lens 100 also includes a coupling-out grating, which is provided on a surface of the substrate 10 away from the coupling-in grating. When the surface of the coupling-out grating is also coated with a film layer, it is possible to further increase the diffraction efficiency.

To achieve the above objective, the present disclosure also proposes a head mounted display (not shown), which includes an image source and the above lens 100, and the lens 100 is located on the light-emergent side of the image source. Since the lens 100 of the head mounted display of the present disclosure refers to the structure of the lens 100 according to the above embodiments, the advantageous effects brought about by the above embodiments will not be described in detail again.

In the present embodiment, the head mounted display may be AR glasses or MR glasses, which include the image source that provides incident light for the lens 100. When the incident light is incident from an air medium into the lens 100, it is first diffracted by the coupling-in grating, then enters the substrate 10, then transmitted by total reflection, then exits from the coupling-out grating, and finally enters the human eye.

To receive the image source as much as possible, when setting the grating structure 30 as the coupling-in grating, the grating structure 30 is positioned directly facing the image source, that is, projections of the image source and the coupling-in grating on the substrate 10 overlap, so as to ensure that all incident light is received by the coupling-in grating, improving light transmission efficiency.

The image source includes a display panel, which may be one of a Liquid Crystal on Silicon (LCOS) display module, a transmissive Liquid Crystal Display (LCD) module, a Digital Light Processing (DLP) display module, or Laser Beam Scanning (LBS). Of course, the image source also includes a light source, optionally an LED light source, providing the light source for the display panel. After passing through the display panel, the incident light is generated and directed towards the lens 100.

The grating structure 30 employs optimized coating design, and may effectively enhance diffraction efficiency and transmission efficiency of the grating. A conformal film layer with high refractive index may improve uniformity across wavelengths and angles, and in turn improve the uniformity of color and brightness of the head mounted display in the spatial position or at different angles.

The above is merely a preferred embodiment of the present disclosure, and is not intended to limit the patent scope of the present disclosure. Any equivalent structural transformations made based on the inventive concept of the present disclosure using the contents of the specification and the accompanying drawings of the present disclosure, or their direct/indirect application in other related technical fields, shall fall within the scope of patent protection of the present disclosure.

1. A grating structure, comprising:
a base, and
a plurality of grating portions provided on a surface of the base, the plurality of grating portions being arranged at intervals along an extension direction of the base,
wherein a surfaces of each of the plurality of grating portions comprises an enhancement layer whose refractive index is greater than a refractive index of the plurality of grating portions, such that the enhancement layers of a first of the plurality of granting portions is different in thickness than the enhancement layer for a second of the plurality of grating portions.

2. The grating structure according to claim 1, wherein in an arrangement direction of the plurality of grating portions, the thickness of the enhancement layer on the surfaces of the plurality of grating portions gradually increases.

3. The grating structure according to claim 1, wherein the surface of each of the plurality of grating portions comprises a top portion parallel to the surface of the base and a side portion connecting the top portion to the surface of the base, and the enhancement layer on the top portion and the side portion differs in thickness.

4. The grating structure according to claim 3, wherein in an arrangement direction of the plurality of grating portions, height of the grating portions is greater than width of the plurality of grating portions, and thickness of the enhancement layer coated on the top portion is greater than thickness of the enhancement layer on the side portion.

5. The grating structure according to claim 4, wherein the enhancement layer is made of one of titanium dioxide, aluminum oxide, and magnesium oxide.

6. The grating structure according to claim 1, wherein thickness of the enhancement layer on the surfaces of the plurality of grating portions ranges from 20 nm to 30 nm.

7. The grating structure according to claim 1, wherein the enhancement layer is configured to be coated through Atomic Layer Deposition, Chemical Vapor Deposition, Physical Vapor Deposition, or Magnetron Sputtering.

8. The grating structure according to claim 1, wherein the base is made of silica or resin;
and/or, the plurality of grating portions are made of silica or resin;
and/or, the grating structure is a binary grating, a blazed grating, an inclined grating, or a multi-step grating.

9. A processing method for the grating structure according to claim 1 comprises:
providing a base, with a plurality of grating portions arranged at intervals along an extension direction of the base on one surface thereof;
coating an enhancement layer on a surface of each of the plurality of grating portions, with a uniform coating thickness;
coating a photoresist on the enhancement layer;
partially covering the photoresist with a mask, and sequentially performing an exposure and development on the photoresist to obtain a retained photoresist;
changing the coating thickness of the enhancement layer not covered by the retained photoresist so that the enhancement layer for a first of the plurality of granting portions is different in thickness than the enhancement layer for a second of the plurality of grating portions.

10. The processing method for the grating structure according to claim 9, wherein the surface of each of the plurality of grating portions comprises a top portion parallel to the surface of the base and a side portion connecting the top portion to the surface of the base;
the partially covering the photoresist with a mask, and sequentially performing an exposure and development on the photoresist to obtain a retained photoresist, comprises:
using the mask to cover the photoresist corresponding to the side portion and the surface of the base, or using the mask to cover the photoresist corresponding to the top portion;
after performing the exposure and development, filling a groove space enclosed by the side portion and the surface of the base with the retained photoresist or locating the retained photoresist on a surface of the enhancement layer coated on the top portion;
and, the changing the coating thickness of the enhancement layer not covered by the retained photoresist so that the enhancement layer for a first of the plurality of granting portions is different in thickness than the enhancement layer for a second of the plurality of grating portions, comprises:
increasing thickness of the enhancement layer coated on the top portion, or reducing thickness the enhancement layer coated on the side portion, so that the enhancement layer on the top portion and side portion of one of the grating portions differs in thickness.

11. The processing method for the grating structure according to claim 10, wherein when filling a groove space enclosed by the side portion and the surface of the base with the retained photoresist, the changing the coating thickness of the enhancement layer not covered by the retained photoresist so that the enhancement layer for a first of the plurality of granting portions is different in thickness than the enhancement layer for a second of the plurality of grating portions, comprises:
controlling the retained photoresist to protrude from the groove space and be higher than thickness of the enhancement layer coated on the top portion;
re-coating an enhancement layer through evaporation or magnetron sputtering on the top portion of at least one of the grating portions, wherein thickness of a re-coated enhancement layer is less than a height by which the retained photoresist protrudes from the groove space.

12. The processing method for the grating structure according to claim 10, wherein when locating the retained photoresist on a surface of the enhancement layer coated on the top portion, changing the coating thickness of the enhancement layer not covered by the retained photoresist so that the enhancement layer for a first of the plurality of granting portions is different in thickness than the enhancement layer for a second of the plurality of grating portions, comprises:
in the arrangement direction of the plurality of grating portions, controlling width of the retained photoresist to be less than width of the enhancement layer coated on the top portion, and setting a width difference between the enhancement layer on the top portion and the retained photoresist as t;
thinning thickness of the enhancement layer on the side portion of at least one of the grating portions, such that the thickness of the enhancement layer on the side portion is less than or equal to t.

13. A lens, comprising a substrate and a grating structure according to claim 1, wherein a surface of the base facing away from the grating portions attaches to a surface of the substrate.

14. A head mounted display, comprising an image source and a lens according to claim 13, wherein the lens is located on a light-emergent side of the image source.
